(19) United States
(12) Patent Application Publication
(10) Pub. No.: US 2013/0176522 A1
(43) Pub. Date: Jul. 11, 2013

(54) ACTIVE DEVICE ARRAY SUBSTRATE AND LIQUID CRYSTAL DISPLAY PANEL

(71) Applicants: Yi-Chun Wu, Hualien County (TW); Wun-Yi Shie, Taichung City (TW); Shuan-Sui Hung, Taichung City (TW); Jun-Jie Huang, Taichung City (TW)

(72) Inventors: Yi-Chun Wu, Hualien County (TW); Wun-Yi Shie, Taichung City (TW); Shuan-Sui Hung, Taichung City (TW); Jun-Jie Huang, Taichung City (TW)

(73) Assignees: WINTEK CORPORATION, Taichung City (TW); Dongguan Masstop Liquid Crystal Display Co., Ltd., Guangdong Province (CN)

(21) Appl. No.: 13/733,895

(22) Filed: Jan. 4, 2013

(30) Foreign Application Priority Data
Jan. 6, 2012 (TW) 101100657

(51) Int. Cl. G02F 1/1343

(52) U.S. Cl. CPC G02F 1/134336
USPC 349/143

(57) ABSTRACT

The active device array substrate including a substrate, a plurality of scan lines, data lines, and pixel units is provided. The scan lines, data lines and pixel units are disposed on the substrate. Each pixel unit is electrically connected the corresponding scan line and data line, and each pixel unit includes an active device, a dielectric layer, and a pixel electrode. The dielectric layer covers the active device and has an opening. The pixel electrode is electrically connected to the active device through the opening of the dielectric layer. The pixel electrode has a slit separating the pixel electrode into a first sub pixel electrode and a second sub pixel electrode, wherein the first and second sub pixel electrodes are electrically connected by two connection portions disposed at two ends of the slit. The protrusions are disposed on each connection portion of the pixel electrode.

### CROSS-REFERENCE TO RELATED APPLICATION

This application claims the priority benefit of Taiwan application serial no. 101100657, filed on Jan. 6, 2012. The entirety of the above-mentioned patent application is hereby incorporated by reference herein and made a part of this specification.

### BACKGROUND

1. Technical Field

The invention relates generally to a substrate and a liquid crystal display (LCD) apparatus, and more particularly to an active device array substrate and an LCD panel.

2. Related Art

Nowadays, the market demands for the development of the thin film transistor liquid crystal display (TFT-LCD) have been trending towards high contrast ratio, no gray scale inversion, high brightness, high color saturation, fast response, and wide viewing angle.

Taking the multi-domain vertically alignment liquid crystal display (MVA-LCD) panel as an example, by employing a plurality of alignment patterns such as alignment protrusions or slits to render the arrangement of the liquid crystal molecules in each pixel in multiple directions, a plurality of domains in different alignments can be obtained. For the conventional MVA-LCD panel, since the alignment protrusions or slits formed on the color filter substrate or the TFT array substrate render the liquid crystal molecules in multi-direction arrangements, a plurality of different alignment domains can be obtained, and therefore the MVA-LCD panel can meet the requirement of wide viewing angle.

In a typical operation, the liquid crystal molecules in the MVA-LCD can be arranged stably. However, when an external force presses the LCD panel, since the cell gap between two substrates changes, an electric field variation is generated at the pressured area. Accordingly, the liquid crystal molecules at the pressured area are chaotically arranged, thereby causing an undesirable display effect. To be specific, after the LCD panel is pressured by the external force (e.g., by a finger press), due to the liquid crystal molecules being affected by the aforementioned distorted electric field, the liquid crystal molecules cannot promptly return to the original arrangement state, thereby resulting in a press mura phenomenon. Moreover, the surface of the LCD panel looks smudged, severely impacting the quality of the LCD panel.

### SUMMARY

The invention provides an active device array substrate capable of alleviating a press mura phenomenon when applied to a liquid crystal display (LCD) panel.

The invention provides an LCD panel, in which liquid crystal molecules can swiftly return to an original arrangement state after being pressed by an external force.

The invention provides an active device array substrate, including a substrate, a plurality of scan lines, a plurality of data lines, and a plurality of pixel units. The scan lines, the data lines, and the pixel units are disposed on the substrate. Each of the pixel units is electrically connected to the corresponding scan line and data line, and each of the pixel units includes an active device, a dielectric layer, and a pixel electrode. The active device is electrically connected to the corresponding scan line and data line. The dielectric layer covers the active layer and has an opening exposing a portion of the active device. The pixel electrode is electrically connected to the active device through the opening of the dielectric layer, in which the pixel electrode has a slit separating the pixel electrode into a first sub pixel electrode and a second sub pixel electrode, and the first sub pixel electrode and the second sub pixel electrode are electrically connected by two connection portions disposed at two ends of the slit. A plurality of alignment structures are respectively located near each of the connection portions of the pixel electrode.

According to an embodiment of the invention, the alignment structures can be protrusions, auxiliary slits, or a combination of protrusions and auxiliary slits. More specifically, the alignment structures can be protrusions respectively disposed on each of the connection portions of the pixel electrode. The alignment structures can be auxiliary slits respectively located at the first sub pixel electrode and the second sub pixel electrode of the pixel electrode adjacent to each of the connection portions.

According to an embodiment of the invention, the active device array substrate further includes a storage electrode disposed between the dielectric layer and the substrate. To be specific, the storage electrode has a first sub storage electrode and a second sub storage electrode, the first sub storage electrode has a projection on the substrate surrounding and overlaping a periphery of the first sub pixel electrode in a projection to the substrate, and the second sub storage electrode has a projection on the substrate surrounding and overlaping a periphery of the second sub pixel electrode in the projection to the substrate.

According to an embodiment of the invention, the protrusions are respectively disposed at the corners of the overlapping portions of the storage electrode and the pixel electrode.

According to an embodiment of the invention, a portion of the protrusions is further disposed at the corners of the first sub pixel electrode near one of the scan lines. At this time, the first sub pixel electrode has a block shape, and the protrusions are respectively disposed at the four corners of the first sub pixel electrode.

According to an embodiment of the invention, a portion of the protrusions is disposed at the corners of the second sub pixel electrode near one of the scan lines. At this time, the second sub pixel electrode has a block shape, and the protrusions are respectively disposed at the four corners of the second sub pixel electrode.

The invention further provides an LCD panel, including an active device array substrate, an opposite substrate, and a liquid crystal layer. The active device array substrate includes a substrate, a plurality of scan lines, a plurality of data lines, and a plurality of pixel units. The scan lines, the data lines, and the pixel units are disposed on the substrate. Each of the pixel units is electrically connected to the corresponding scan line and data line, and each of the pixel units includes an active device, a dielectric layer, a pixel electrode, and a plurality of protrusions. The active device is electrically connected to the corresponding scan line and data line. The dielectric layer covers the active device. The pixel electrode is electrically connected to the active device through the opening of the dielectric layer, in which the pixel electrode has a slit separating the pixel electrode into a first sub pixel electrode and a second sub pixel electrode, and the first sub pixel electrode and the second sub pixel electrode are electrically connected by two connection portions disposed at two ends of the slit. A plurality of alignment structures are respectively located near each of the connection portions. The opposite substrate is disposed opposite to the active device array substrate. The liquid crystal layer is disposed between the active device array substrate and the opposite substrate.

According to an embodiment of the invention, the opposite substrate includes a plurality of alignment protrusions. Each of the alignment protrusions is respectively disposed at a center between the first sub pixel electrode and the second sub pixel electrode.

In summary, according to some embodiments of the invention, the alignment structures (protrusions, auxiliary slits or a combination of protrusions and auxiliary slits) are located near the connection portions of the two sub pixel electrodes in the pixel electrode of the active device array substrate and the LCD panel. Accordingly, the alignment structures (protrusions, auxiliary slits or a combination of protrusions and auxiliary slits) can help the liquid crystal molecules above to rapidly tilt in the correct direction, so the LCD panel can swiftly return to an original state after being pressed by an external force, and the press mura issue is unlikely to occur.

Several exemplary embodiments accompanied with figures are described in detail below to further describe the disclosure in details.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic top view illustrating an active device array substrate according to an embodiment of the invention.

FIG. 2 is a schematic cross-sectional view of FIG. 1 along a line II-II.

FIG. 3A is a schematic cross-sectional view of an LCD panel according to an embodiment of the invention.

FIG. 3B is a top view of an arrangement state of the liquid crystal molecules in the LCD panel of FIG. 3A after being influenced by the alignment protrusions of the opposite substrate.

FIGS. 4A-4C are respective schematic layout diagrams of the storage electrode, pixel electrode, and the protrusions on a substrate in the active device array substrate according to an embodiment of the invention.

FIG. 5A illustrates schematic views of different display states of an LCD panel under different external force pressures according to an embodiment of the invention.

FIG. 5B illustrates a comparative example where protrusions are not configured at the corners of a first sub pixel electrode and a second sub pixel electrode.

FIG. 6 is a schematic top view illustrating an active device array substrate according to another embodiment of the invention.

FIGS. 7A-7E are a schematic top view illustrating the shapes of the alignment structures according to an embodiment of the invention.

### DESCRIPTION OF EMBODIMENTS

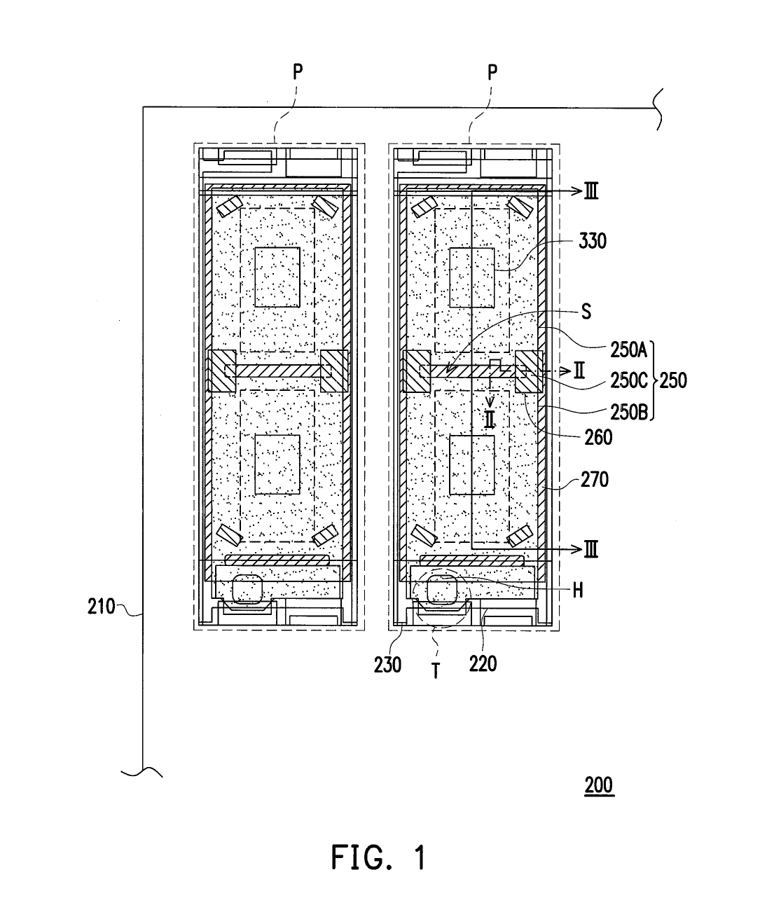

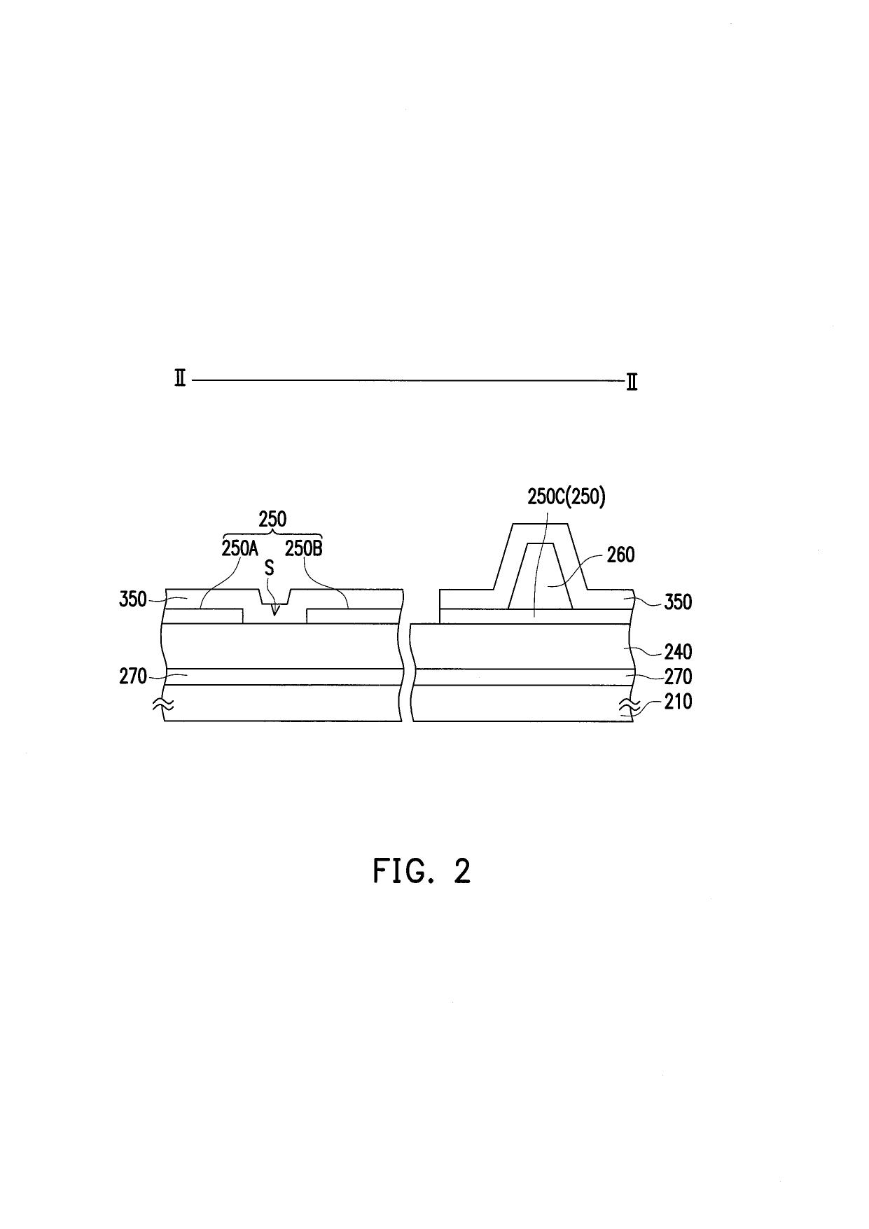

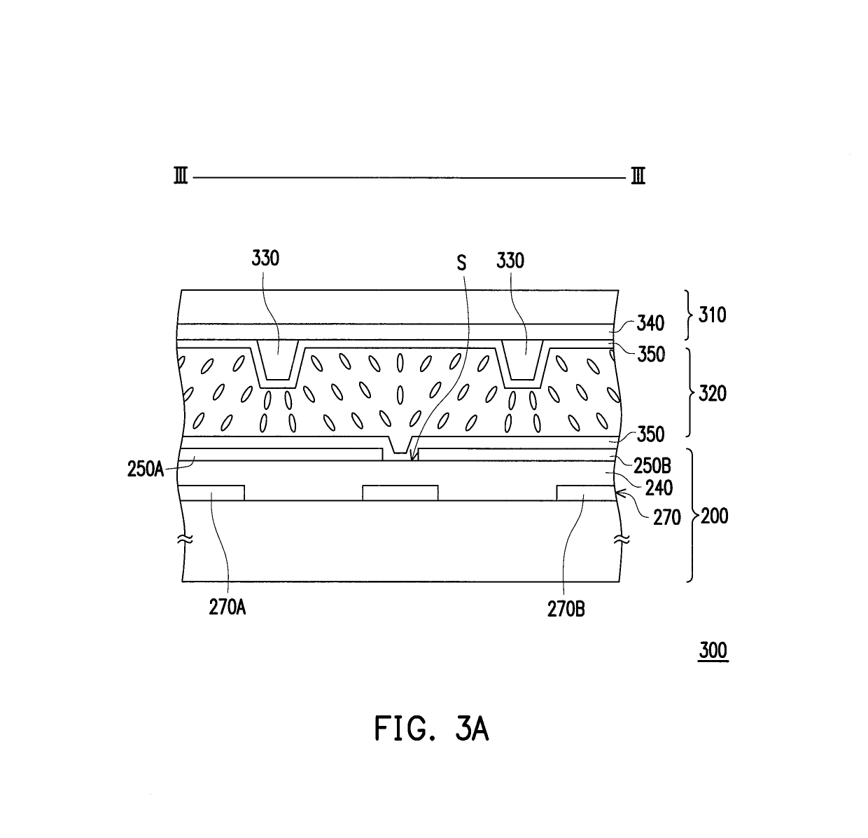

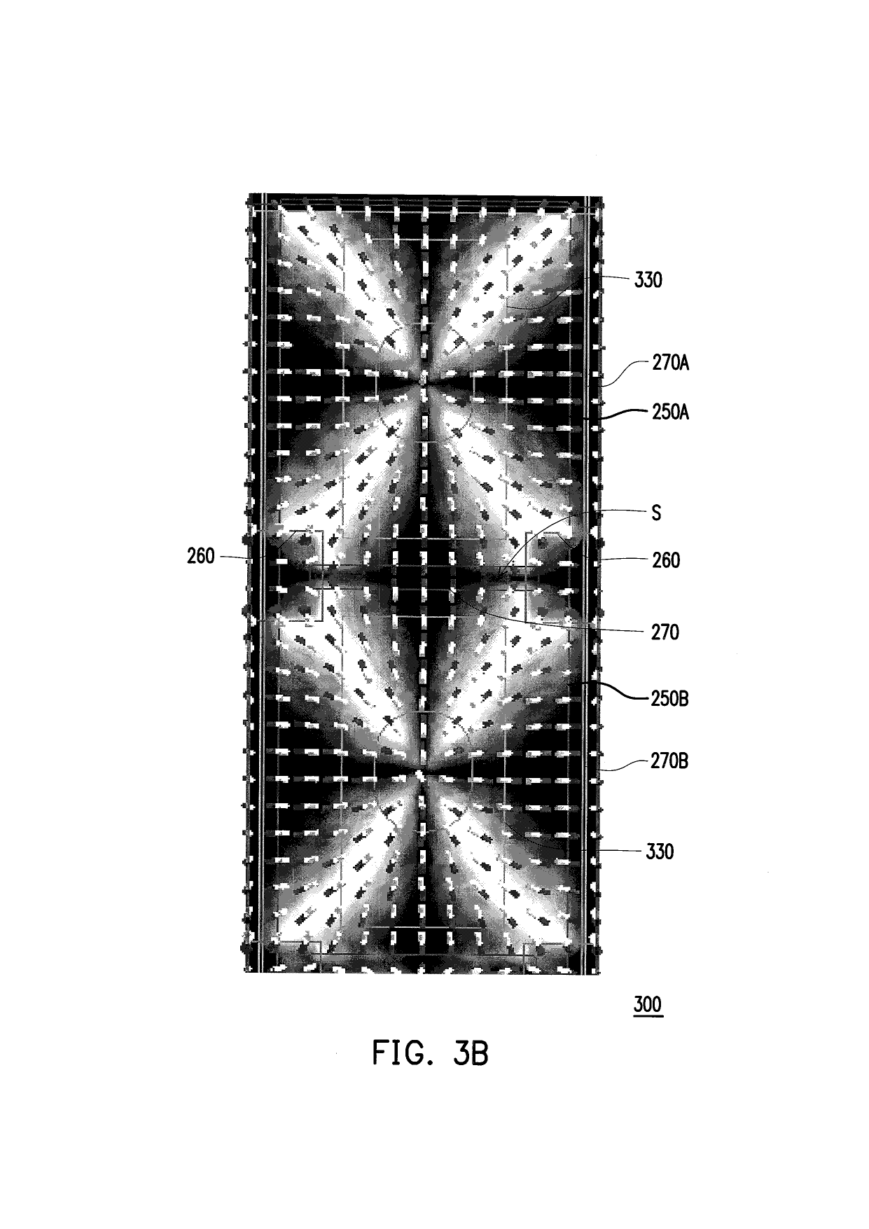

FIG. 1 is a schematic top view illustrating an active device array substrate according to an embodiment of the invention. FIG. 2 is a schematic cross-sectional view of FIG. 1 along a line II-II. As shown in FIGS. 1 and 2, an active device array substrate 200 includes a substrate 210, a plurality of scan lines 220, a plurality of data lines 230, and a plurality of pixel units P. The scan lines 220, data lines 230, and pixel units P are disposed on the substrate 210. Each of the pixel units P is electrically connected to the corresponding scan line 220 and data line 230. Moreover, each of the pixel units P includes an active device T, a dielectric layer 240, and a pixel electrode 250. In the present embodiment, the pixel units P further includes a storage electrode 270 and a reference location for drawing an alignment protrusion. Further description of the alignment protrusion 330 is provided in FIG. 3A and later in the specification.

The active device T is electrically connected to the corresponding scan line 220 and data line 230. In specifics, the active device T has a gate, a source, a drain, and a channel. The gate is electrically connected to the scan line 220 to control the switching of the active device T. The source is electrically connected to the data line 230 to transmit a data signal on the data line 230. A channel layer is disposed on a gate insulating layer above the gate, and the channel layer is disposed between the source and the drain. The dielectric layer 240 is disposed above and covers the active device T, and the dielectric layer 240 has an opening H disposed above the drain of the active device T. The pixel electrode 250 is electrically connected to the drain of the active device T through the opening H of the dielectric layer 240.

As shown in FIGS. 1 and 2, the pixel electrode 250 has a slit S separating the pixel electrode 250 into a first sub pixel electrode 250A and a second sub pixel electrode 250B. The first sub pixel electrode 250A and the second sub pixel electrode 250B are electrically connected by two connection portions 250C disposed at two ends of the slit S. In particular, a plurality of protrusions 260 are respectively disposed on each of the connection portions C of the pixel electrode 250, and the protrusions 260 overlaps a projection of the corresponding connection portion 250C on the substrate 210. When an alignment film 350 covers the protrusions 260, the protrusions 260 are disposed between the alignment film 350 and each of the connection portions C of the pixel electrode 250.

To be specific, FIG. 3A is a schematic cross-sectional view of an LCD panel according to an embodiment of the invention, in which the cross-sectional view illustrating the active device array substrate 210 in the LCD panel is the same as a cross-section along a line III-III in FIG. 1. As shown in FIG. 3A, an LCD panel 300 includes an opposite substrate 310 disposed opposite to the active device array substrate 210. Moreover, a liquid crystal layer 320 is disposed between the active device array substrate 210 and the opposite substrate 310. In specifics, the opposite substrate 310 includes a plurality of alignment protrusions 330 and a common electrode 340. Moreover, an alignment film 350 is respectively disposed on the active device array substrate 210 and on an opposite surface of the opposite substrate 310. Besides, the storage electrode 270 has a first sub storage electrode 270A and a second sub storage electrode 270B. Each of the alignment protrusions 330 is respectively disposed at a center between the first sub pixel electrode 250A and the second sub pixel electrode 250B, so the liquid crystal molecules in each of the pixel electrodes 250 can be rendered in a multi-direction arrangement, thereby obtaining a plurality of different alignment domains.

It should be noted that, since the connection portions 250C of the first sub pixel electrode 250A and the second sub pixel electrode 250B alters the electrical line distribution in the liquid crystal layer 320, the titled electric field originally promoting the tilting of the liquid crystal molecules is weakened by the shielding of the connection portions 250C. Therefore, when an external force presses the LCD panel 300, because of the vertical electrical field on the connection portions 250C, the tilted electric field thereon is weakened. Accordingly, the liquid crystal molecules located above the connection portions 250C cannot return swiftly to the original arrangement state, thereby generating the press mura issue. Referring to FIGS. 1 and 2, according to an embodiment of the invention, on the active device array substrate 210 and on the connection portions 250C corresponding to the first sub pixel electrode 250A and the second sub pixel electrode 250B, the protrusions 260 are disposed between the connection portions 250C and the alignment film 350. Since the protrusions 260 have a slanted structure, the protrusions 260 can help the liquid crystal molecules above the protrusions 260 to tilt in the proper direction. Accordingly, the liquid crystal molecules can swiftly return to the original arrangement state after being pressed, and the press mura issue is unlikely to be generated.

FIG. 3B is a top view of an arrangement state of the liquid crystal molecules in the LCD panel of FIG. 3A after being influenced by the alignment protrusions 330 of the opposite substrate 310. As shown in FIG. 3B, under normal operation, even when protrusions 260 are correspondingly configured above the connection portions 250C of the first sub pixel electrode 250A and the second sub pixel electrode 250B, the liquid crystal molecules can still be stably arranged, and the normal arrangement of the liquid crystal molecules is not disturbed. Moreover, when the external force presses the LCD panel 300, the protrusions 260 can help the liquid crystal molecules above to tilt in the correct direction, as further elaborated below.

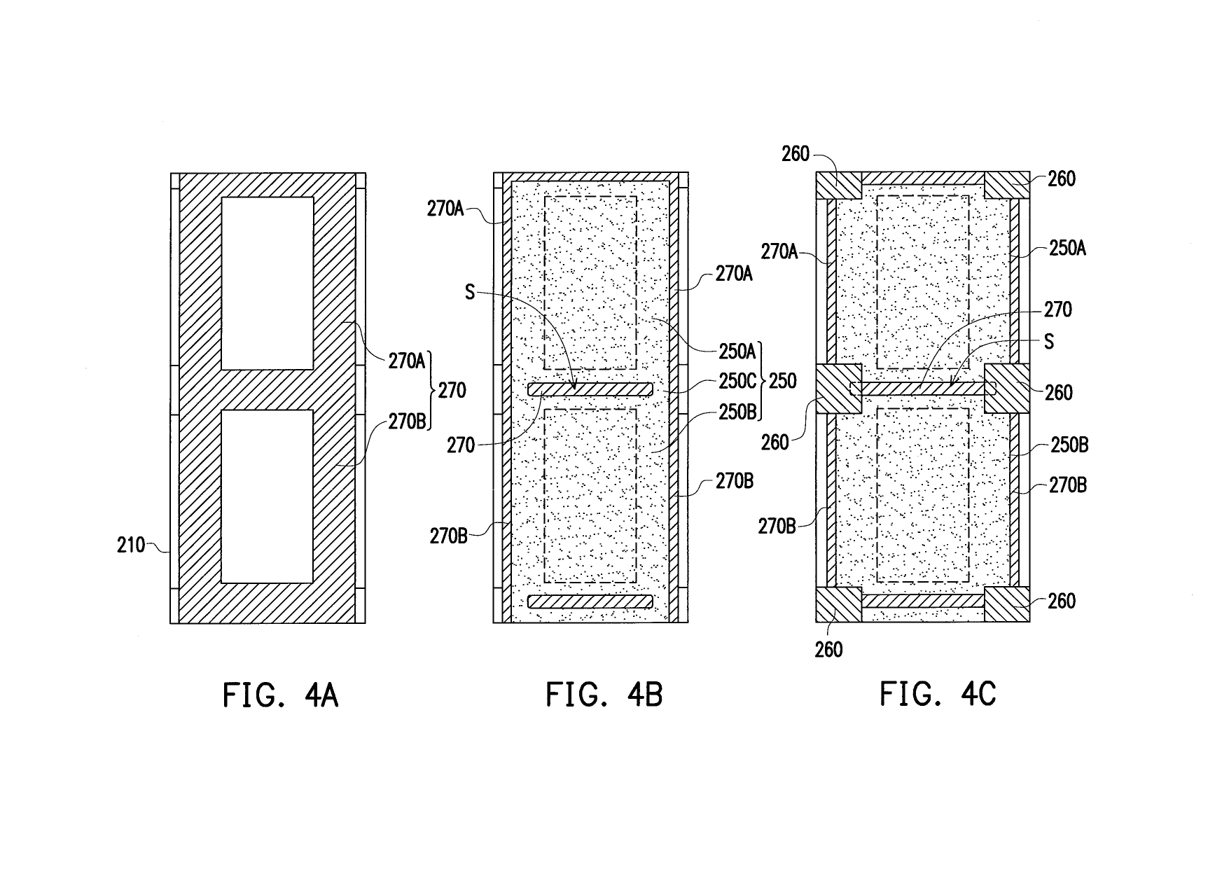

In order to clearly describe the stacking order and layout of each film layer on the active device array substrate, FIGS. 4A-4C are respective schematic layout diagrams of the storage electrode, pixel electrode, and the protrusions on a substrate in the active device array substrate according to an embodiment of the invention. FIG. 4A is a schematic layout diagram of a storage electrode in the pixel units P. As shown in FIGS. 2 and 4A, the storage electrode 270 is disposed between the dielectric layer 240 and the substrate 210, and the storage electrode 270 has a first sub storage electrode 270A and a second sub storage electrode 270B. FIG. 4B is a schematic layout diagram illustrating the pixel electrode 250 disposed on the storage electrode 270. As shown in FIG. 4B, the first sub storage electrode 270A has a projection on the substrate surrounding and overlaping a periphery of the first sub pixel electrode 250A in the projection to the substrate 210. Moreover, the second sub storage electrode 270B has a projection on the substrate surrounding and overlaping a periphery of the second sub pixel electrode 250B in the projection to the substrate 210. A first storage capacitor may be generated between the first sub storage electrode 270A, the dielectric layer 240, and the first sub pixel electrode 250A, and a second storage capacitor may be generated between the second sub storage electrode 270B, the dielectric layer 240, and the second sub pixel electrode 250B. Accordingly, the display quality of the LCD panel 300 can be enhanced. Furthermore, since the storage electrode 270 is laid out at the slit S area of the pixel electrode 250, the storage electrode 270 can accordingly strengthen the tilted electric field of the pixel electrode 250 at the silt S area, thereby further helping to promote the titling of the liquid crystal molecules thereon.

FIG. 4C is a schematic layout diagram illustrating the protrusions disposed on the pixel electrode. As shown in FIG. 4C, the protrusions are respectively disposed at the corners of the overlapping portions of the storage electrode 270 and the pixel electrode 250. In specifics, a portion of the protrusions 260 can be further disposed at the corners of the first sub pixel electrode 250A near one of the scan lines 220. At this time, the first sub pixel electrode 250A has a block shape, for example, and the protrusions 260 can be further respectively disposed at the four corners of the first sub pixel electrode 250A. Moreover, a portion of the protrusions 260 is disposed at the corners of the second sub pixel electrode 250B near one of the scan lines 220. At this time, the second sub pixel electrode 250B has a block shape, and the protrusions 260 are respectively disposed at the four corners of the second sub pixel electrode 250B.

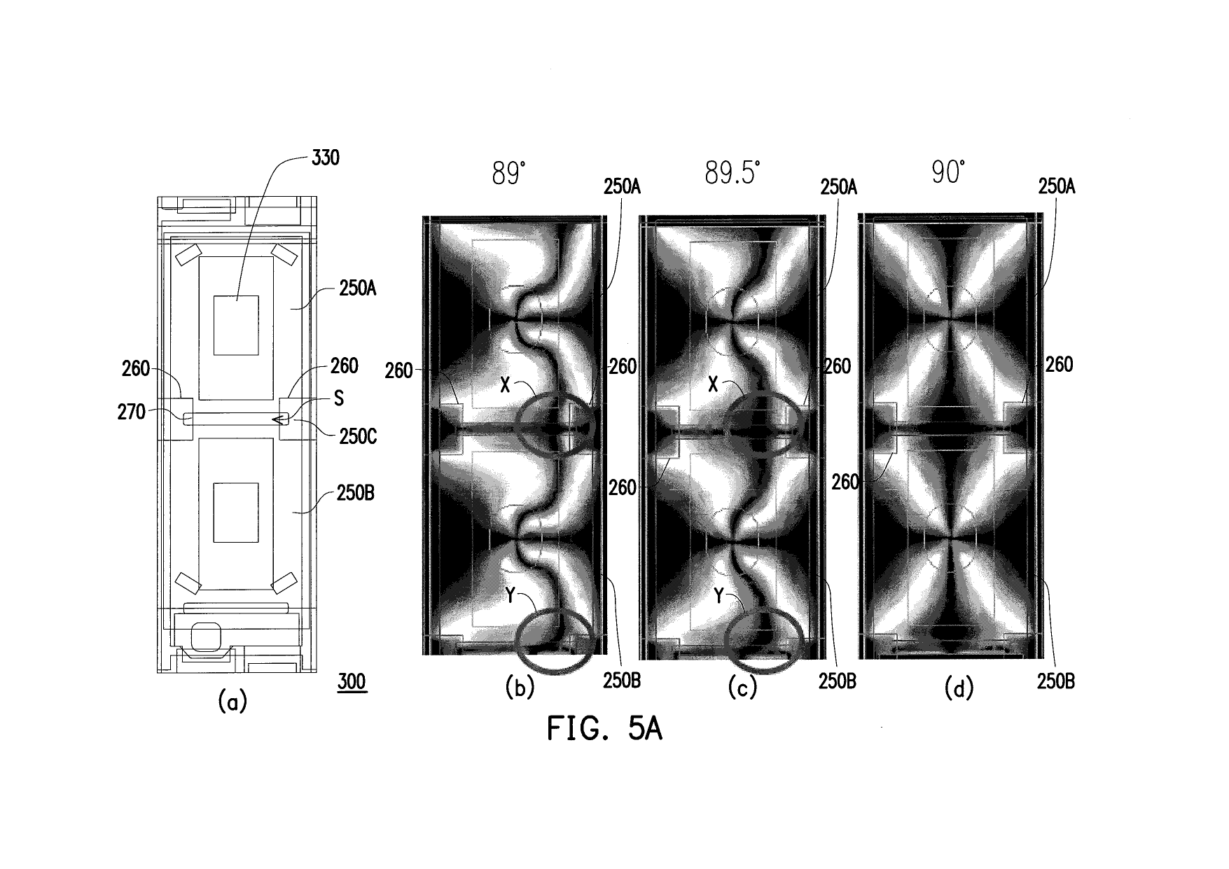

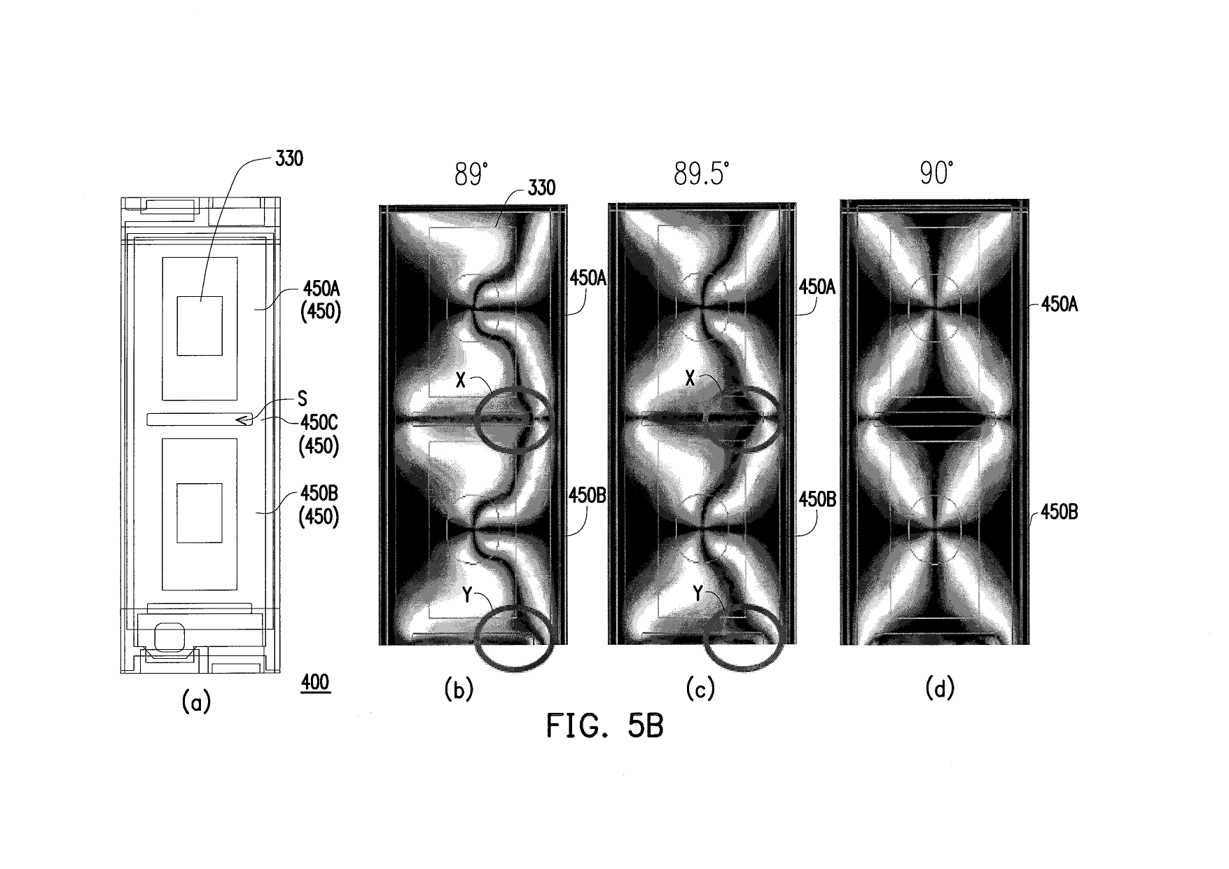

FIG. 5A illustrates schematic views of different display states of an LCD panel under different external force pressures according to an embodiment of the invention. The LCD panel 300 depicted in FIG. 5A has the afore-described active device array substrate 210, as shown by the pixel structure illustrated in (a) of FIG. 5A. The protrusions 260 are respectively disposed at the corners of the first sub pixel electrode 250A and the second sub pixel electrode 250B. Moreover, the protrusions 260 are correspondingly disposed at the connection portions 250C of the two sub pixel electrodes 250A and 250B. The first sub pixel electrode 250A is connected to the second sub pixel electrode 250B through the connection portions 250C. In (d) of FIG. 5A, a display state of an alignment at 90 degrees is illustrated, representing the display state in which the LCD panel 300 has not been pressed.

In FIG. 5A, (b) and (c) respectively illustrates the display states of an alignment at 89 degrees and an alignment at 89.5 degrees, representing the degrees of pressure resistance for the LCD panel 300 under various levels of external force pressures. By comparing (b) and (c) of FIG. 5A with different levels of the external force pressures and (d) of FIG. 5A without the external force, it should be noted that the cross patterns at areas X and Y circled in (b) and (c) of FIG. 5A have a small offset to the edge. Accordingly, the pressure resistance capability thereof is strong, and the press mura issue is unlikely to occur.

In contrast, FIG. 5B illustrates a comparative example where protrusions are not configured at the corners of a first sub pixel electrode 450A and a second sub pixel electrode 450B. The first sub pixel electrode 450A and the second sub pixel electrode 450B are connected through the connection portions 450C. In the comparative example, (a) of FIG. 5B illustrates the pixel structure of an LCD panel 400, and (d) of FIG. 5B illustrates a display state in which LCD panel 400 has not been pressed, as in (d) of FIG. 5A. Moreover, (b) and (c) of FIG. 5B respectively illustrates the display states of an alignment at 89 degrees and an alignment at 89.5 degrees, representing the degrees of pressure resistance for the LCD panel 400 under various levels of external force pressures.

Referring to (b) of FIG. 5A in the invention and (b) of FIG. 5B in the comparative example, under the same degree of external force pressure, compared to the LCD panel 300 in the invention illustrated in (b) of FIG. 5A, the LCD panel 400 in the comparative example illustrated in (b) of FIG. 5B has greater offset of the cross pattern at the X and Y areas from the center to the edge. Therefore, when an external force presses the LCD panel, the LCD panel 300 in the invention has a preferable pressure resistance capability compared to the LCD panel 400 in the comparative example. Similarly, referring to (c) of FIG. 5A in the invention and (b) of FIG. 5B in the comparative example, under the same degree of external force pressure, compared to (c) of FIG. 5A in the invention, the comparative example illustrated in (c) of FIG. 5B has greater offset of the cross pattern at the X and Y areas from the center to the edge. Therefore, the tilting of liquid crystal molecules can be helped by the slanted structures of the protrusions 260, so that after the LCD panel 300 experiences the external force pressure, the press mura issue is unlikely to occur.

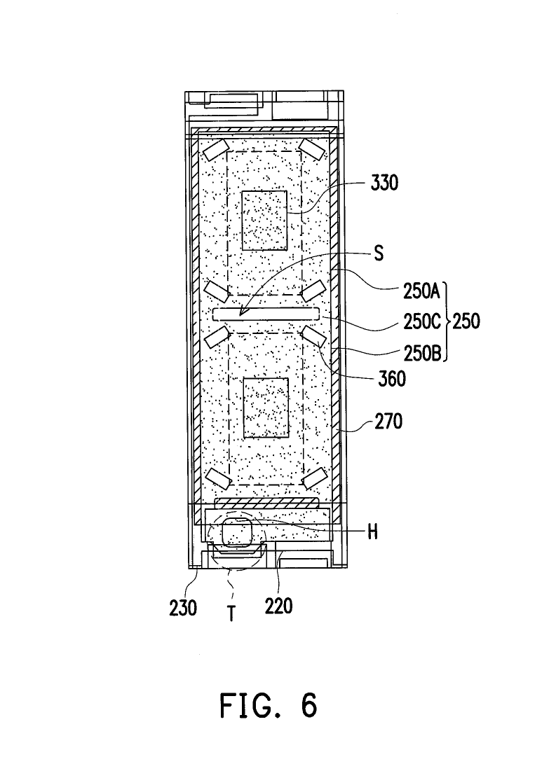

Referring to FIG. 6, in this embodiment, the protrusions 260 of an active device array substrate according to an embodiment of the invention shown in FIG. 1 can be replaced by auxiliary slits 360. More specifically, the auxiliary slits 360 are respectively located at the first sub pixel electrode 250A adjacent to each of the connection portions 250C and located at the second sub pixel electrode 250B adjacent to each of the connection portions 250C. By this way, the tilting of liquid crystal molecules can be helped by the auxiliary slits 360 so that after the LCD panel 300 experiences the external force pressure, the press mura issue is unlikely to occur. In other words, by setting the alignment structures, such as protrusions, auxiliary slits, or the combination of protrusions and auxiliary slits on the connection portions of the first sub pixel electrode and the second sub pixel electrode in the active device array substrate and the LCD panel according to some embodiments of the invention, the liquid crystal molecules can be correctly tilted in accordance with the auxiliary slits formed by pixel electrode. Therefore, the LCD panel can swiftly return to an original state after being pressed by an external force, and the press mura issue is unlikely to occur.

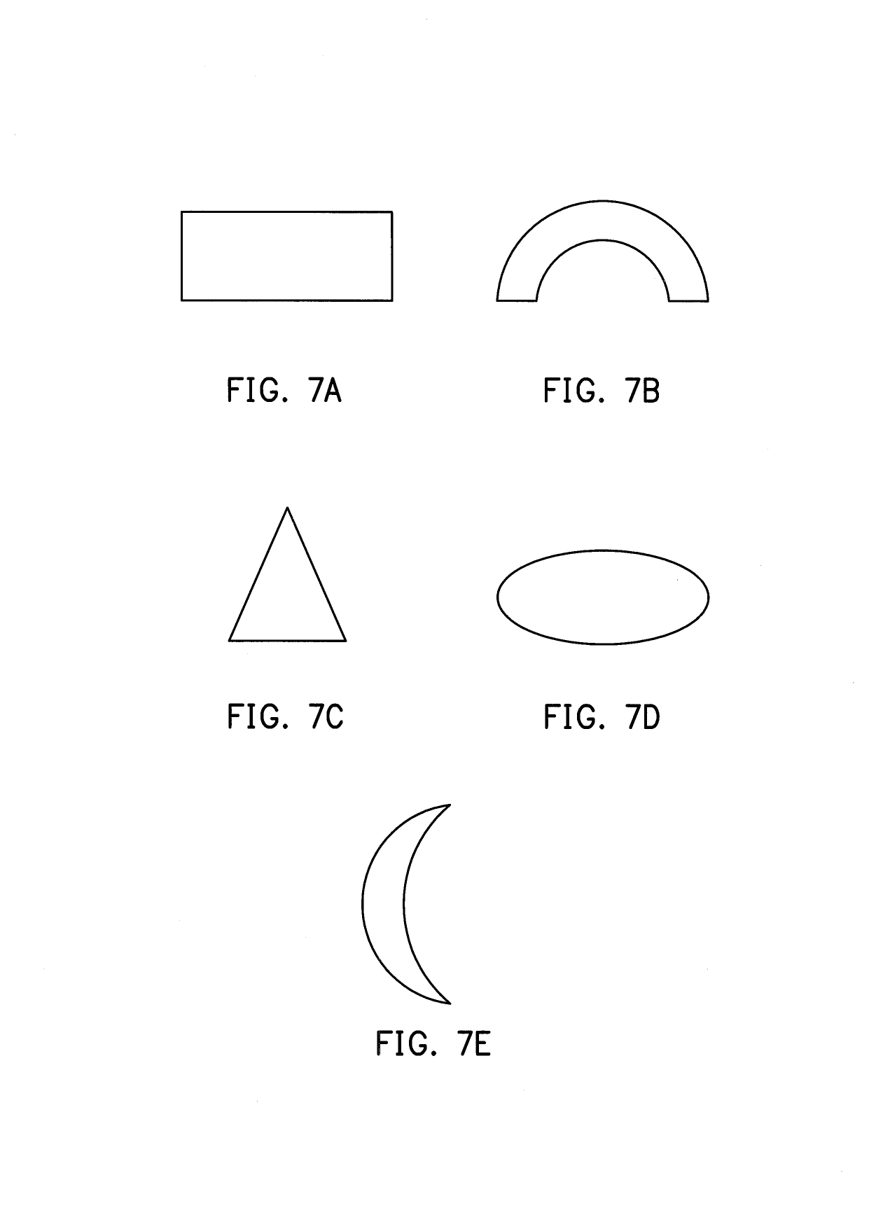

Moreover, the shapes of the alignment structures (protrusions and auxiliary slits) can be exemplified by FIGS. 7A-7E, which include rectangular, arch, triangle, oval/circle, moon-shaped.

In view of the foregoing, since alignment structures (protrusions, auxiliary slits) are disposed on the connection portions of the first sub pixel electrode and the second sub pixel electrode or disposed at the first sub pixel electrode and the second sub pixel electrode of the pixel electrode adjacent to each of the connection portions in the active device array substrate and the LCD panel according to some embodiments of the invention, the liquid crystal molecules can be correctly tilted in accordance with the slanted structures on the protrusions. Therefore, the LCD panel can swiftly return to an original state after being pressed by an external force, and the press mura issue is unlikely to occur.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. An active device array substrate, comprising:
a substrate;
a plurality of scan lines and a plurality of data lines disposed on the substrate;
a plurality of pixel units disposed on the substrate, each of the pixel units is electrically connected to the corresponding scan line and data line, wherein each of the pixel units comprises:
an active device electrically connected to the corresponding scan line and data line;
a dielectric layer covering the active layer and having an opening exposing a portion of the active device;
a pixel electrode electrically connected to the active device through the opening of the dielectric layer, wherein the pixel electrode has a slit separating the pixel electrode into a first sub pixel electrode and a second sub pixel electrode, and the first sub pixel electrode and the second sub pixel electrode are electrically connected by two connection portions disposed at two ends of the slit; and
a plurality of alignment structures respectively located near each of the connection portions of the pixel electrode.

2. The active device array substrate as claimed in claim 1, wherein the alignment structures are protrusions, auxiliary slits, or a combination of protrusions and auxiliary slits.

3. The active device array substrate as claimed in claim 1, wherein the alignment structures are protrusions, and the plurality of protrusions respectively disposed on each of the connection portions of the pixel electrode.

4. The active device array substrate as claimed in claim 3, further comprising a storage electrode disposed between the dielectric layer and the substrate.

5. The active device array substrate as claimed in claim 4, wherein the storage electrode has a first sub storage electrode and a second sub storage electrode, the first sub storage electrode has a projection on the substrate surrounding and overlapping a periphery of the first sub pixel electrode, and the second sub storage electrode has a projection on the substrate surrounding and overlapping a periphery of the second sub pixel electrode.

6. The active device array substrate as claimed in claim 5, wherein the protrusions are respectively disposed at the corners of the overlapping portions of the storage electrode and the pixel electrode.

7. The active device array substrate as claimed in claim 3, wherein a portion of the protrusions are further disposed at the corners of the first sub pixel electrode near one of the scan lines.

8. The active device array substrate as claimed in claim 7, wherein the first sub pixel electrode has a block shape, and the protrusions are respectively disposed at the four corners of the first sub pixel electrode.

9. The active device array substrate as claimed in claim 1, wherein a portion of the protrusions are further disposed at the corners of the second sub pixel electrode near one of the scan lines.

10. The active device array substrate as claimed in claim 9, wherein the second sub pixel electrode has a block shape, and the protrusions are respectively disposed at the four corners of the second sub pixel electrode.

11. The active device array substrate as claimed in claim 1, wherein the alignment structures are auxiliary slits, and the plurality of auxiliary slits respectively located at the first sub pixel electrode and the second sub pixel electrode of the pixel electrode adjacent to each of the connection portions.

12. The active device array substrate as claimed in claim 11, further comprising a storage electrode disposed between the dielectric layer and the substrate.

13. The active device array substrate as claimed in claim 12, wherein the storage electrode has a first sub storage electrode and a second sub storage electrode, the first sub storage electrode has a projection on the substrate surrounding and overlapping a periphery of the first sub pixel electrode, and the second sub storage electrode has a projection on the substrate surrounding and overlapping a periphery of the second sub pixel electrode.

14. The active device array substrate as claimed in claim 13, wherein the auxiliary slits are respectively located at the corners of the overlapping portions of the storage electrode and the pixel electrode.

15. The active device array substrate as claimed in claim 11, wherein a portion of the auxiliary slits are further located at the corners of the first sub pixel electrode near one of the scan lines.

16. The active device array substrate as claimed in claim 15, wherein the first sub pixel electrode has a block shape, and the auxiliary slits are respectively located at the four corners of the first sub pixel electrode.

17. The active device array substrate as claimed in claim 11, wherein a portion of the auxiliary slits are further located at the corners of the second sub pixel electrode near one of the scan lines.

18. The active device array substrate as claimed in claim 17, wherein the second sub pixel electrode has a block shape, and the auxiliary slits are respectively located at the four corners of the second sub pixel electrode.

19. A liquid crystal display (LCD) panel, comprising:
an active device array substrate, comprising:
a substrate;
a plurality of scan lines and a plurality of data lines disposed on the substrate;
a plurality of pixel units disposed on the substrate, each of the pixel units is electrically connected to the corresponding scan line and data line, wherein each of the pixel units comprises:
an active device electrically connected to the corresponding scan line and data line;
a dielectric layer covering the active layer and having an opening exposing a portion of the active device;
a pixel electrode electrically connected to the active device through the opening of the dielectric layer, wherein the pixel electrode has a slit separating the pixel electrode into a first sub pixel electrode and a second sub pixel electrode, and the first sub pixel electrode and the second sub pixel electrode are electrically connected by two connection portions disposed at two ends of the slit; and
a plurality of alignment structures respectively located near each of the connection portions of the pixel electrode;
an opposite substrate disposed opposite to the active device array substrate; and
a liquid crystal layer disposed between the active device array substrate and the opposite substrate.

20. The LCD panel as claimed in claim 19, wherein the opposite substrate comprises a plurality of alignment protrusions, each of the alignment protrusions is respectively disposed at a center between the first sub pixel electrode and the second sub pixel electrode.
